(19) United States
(12) Patent Application Publication
(10) Pub. No.: US 2025/0061483 A1
(43) Pub. Date: Feb. 20, 2025

(54) System and Method for Tracking Messages in an Electronic Messaging Campaign

(71) Applicant: iwinBACK Sales Inc., Vancovuer (CA)

(72) Inventors: Larrie YORK, Vancouver (CA); Jeff Scott SUMMERS, Vancouver (CA)

(73) Assignee: iwinBACK Sales Inc., Vancovuer (CA)

(21) Appl. No.: 18/235,086

(22) Filed: Aug. 17, 2023

(51) Int. Cl. G06Q 30/0242; G06Q 50/00

(52) U.S. Cl. CPC G06Q 30/0246; G06Q 50/01; H04L 67/535

(57) ABSTRACT

Disclosed is an electronic platform, system, and method for analyzing data and communications for an electronic messaging campaign. The system comprises a processor executing instructions. The instructions comprise: managing a database containing messaging campaigns and users receiving the communications; creating a set of user accounts for users to be exposed to a first messaging campaign, the user accounts including user details, email accounts and SMS numbers; tracking the email accounts for email messages received relating to the first messaging campaign; analyzing the user accounts of the email accounts against criteria associated with the first messaging campaign; tracking the SMS numbers for SMS messages received relating to the first messaging campaign; and analyzing the user accounts of the SMS messages received against parameters associated with the first messaging campaign.

### FIELD OF THE DISCLOSURE

The present disclosure relates to systems and methods for tracking, monitoring, and analyzing aspects of electronic distribution events, with their electronic messaging campaigns, such as advertisement campaigns.

### DESCRIPTION OF THE BACKGROUND

Messaging campaigns, such as advertising for companies and enterprises, is a practical business necessity. Where a messaging campaign is an advertisement campaign, such the advertisement campaign typically involves various media and platforms, namely advertisements pushed through any one or more of print, radio, television, newspaper, billboard, telephone, text messaging, internet, and social advertisement campaigns.

There are issues with tracking impact and reception of messages in digital-based messaging campaigns.

There is a need to address deficiencies in the prior art.

### SUMMARY OF THE DISCLOSURE

In a first aspect of an embodiment for this disclosure, a communications analysis system for analyzing data and communications for an electronic messaging campaign is provided. The system comprises a processor executing instructions. The instructions comprise: managing a database containing messaging campaigns and users receiving the communications; creating a set of user accounts for users to be exposed to a first messaging campaign, the user accounts including user details, email accounts and device contact numbers (e.g. an SMS number or equivalent “telephone” numbers); tracking the email accounts for email messages received relating to the first messaging campaign; analyzing the user accounts of the email accounts against criteria associated with the first messaging campaign; tracking the device contact numbers for messages received relating to the first messaging campaign; and analyzing the user accounts of the messages received against parameters associated with the first messaging campaign. For a first user account of the user accounts: its email account is selected from a reserved set of email accounts from a list of virtual email accounts; its device contact number is selected from a reserved set of device contact numbers from a list of virtual device contact numbers; and its device is a virtual electronic device.

In the system a second user account of the user accounts may be provided where: its email account is associated with an actual user; its device contact number is an SMS number associated with the actual user; and its device is a physical device.

The system may further: receive a communication sent from the first user account to the system; identify a response to the communication; send the response to the first user account; and track the communication and response in the database.

In the receiving system, the communication may be an email message; and the response output may be an SMS message.

In the system, after the actual user sends a communication to cancel an order to the system, the system may track events around the communication and the order.

In the system, before a communication is sent the first user account, the privileges of the first user account may be compared against restrictions for the campaign.

In the system, communications between the first user account and the system may be tracked and analyzed and a graphical representation of the communications is generated.

In the system, the processor may further executes instructions that: associate the set of user accounts with a second messaging campaign; track the email accounts for email messages received relating to the second messaging campaign; analyze the users accounts of the email accounts against parameters associated with the second messaging campaign; track the SMS numbers for SMS messages received relating to the second messaging campaign; analyze the user accounts of the SMS messages received against parameters associated with the second messaging campaign; and generate data relating to performance criteria for the first and second messaging campaigns.

In the system, the data may relate to response times for the first and second messaging campaigns.

In the system, the data may further relate to cost parameters for the first and second messaging campaigns.

In the system, the processor may further execute instructions that: for the first messaging campaign, identify a response electronic message to be sent to a user account when a message received from the user account matches a criteria; send the response message to the user account; and track and measure a latency between receipt of the message and sending of the response message.

In the system, the processor may further execute instructions that: for the second messaging campaign, identify a second response electronic message to be sent to the user account when the message is received from the user account matching the criteria; send the second response message to the user account; and track and measure a latency between receipt of the message and sending of the second response message.

In the system, the processor may further execute instructions that create a graphical user interface (GUI) showing a connection of messages between the user account and the system with their timing aspects and types of communication. The processor may further still execute instructions that upon determining that one account of the user accounts does not meet the criteria of the first messaging campaign, send a message to that one account notifying of the unmet criteria.

In the system, the unmet criteria may relate to either a location of the user account or an age of the user holding the user account.

In a second aspect, a method for analyzing data and communications for an electronic messaging campaign is provided. In the method, instructions on a processor are executed that: manage a database containing messaging campaigns and users receiving the communications; create a set of user accounts for users to be exposed to a first messaging campaign, the user accounts including user details, email accounts and device contact numbers; track the email accounts for email messages received relating to the first messaging campaign; analyze the user accounts of the email accounts against criteria associated with the first messaging campaign; track the device contact numbers for messages received relating to the first messaging campaign; and analyze the user accounts of the messages received against parameters associated with the first messaging campaign. In the method, for a first user account of the user accounts: its email account is selected from a reserved set of email accounts from a list of virtual email accounts; its device contact number is selected from a reserved set of device contact numbers from a list of virtual device contact numbers; and its device is a virtual electronic device.

In the method, a second user account of the user accounts may be provided, having: its email account being associated with an actual user; its device contact number is an SMS number associated with the actual user; and its device being a physical device.

The method may further comprise executing instructions on the process to: receive a communication sent from the first user account to the system; identify a response to the communication; send the response to the first user account; and track the communication and response in the database.

A server and/or a device may be provided to implement any aspects of the method described.

In other aspects various combinations of sets and subsets of the above aspects are provided.

### BRIEF DESCRIPTION OF THE DRAWINGS

Embodiments of the disclosure will now be described, by way of example only, with reference to the accompanying drawings, in which:

FIG. 1a is a schematic block diagram of an environment for a communication tracking platform with its database according to an embodiment;

FIG. 1b is a schematic block diagram of exemplary records in the database for the tracking platform according to an embodiment as shown in FIG. 1a;

FIG. 1c is a second schematic block diagram of exemplary records in the database for the tracking platform according to an embodiment as shown in FIG. 1a;

FIG. 2 is a schematic block diagram of the tracking platform and its database according to an embodiment as shown in FIG. 1a;

FIG. 3 is a block diagram flow chart of a campaign processing algorithm implemented by the platform for an embodiment of FIG. 1;

FIG. 4a is a block diagram flow chart of a tracking algorithm for emails implemented by the platform for an embodiment of FIG. 1;

FIG. 4b is a block diagram flow chart of a tracking algorithm for telephone calls/text messages implemented by the platform for an embodiment of FIG. 1;

FIG. 4c is a schematic diagram of a graphical user interface (GUI) screen generated by the tracking algorithms of FIGS. 4a and 4b;

FIG. 5 is a block diagram flow chart of a user review algorithm implemented by the platform for an embodiment of FIG. 1;

FIG. 6 is a block diagram flow chart of a communications management algorithm implemented by the platform for an embodiment of FIG. 1;

FIG. 7 is a block diagram flow chart of a communication history graphing algorithm implemented by the platform for an embodiment of FIG. 1;

FIGS. 8a-8d are a set of schematic diagrams of GUIs screens generated by the graphing algorithm of FIG. 7; and

FIG. 9 is a block diagram flow chart of a communication response management algorithm implemented by the platform for an embodiment of FIG. 1.

### DETAILED DESCRIPTION OF EMBODIMENTS

Exemplary details of embodiments are provided herein. The description which follows and embodiments described therein are provided by way of illustration of an example or examples of particular embodiments of principles of the present disclosure. These examples are provided for the purposes of explanation and not limitation of those principles and of the disclosure. In the description which follows, like parts are marked throughout the specification and the drawings with the same respective reference numerals.

An embodiment is depicted in an electronic tracking platform that provides facilities to store, distribute, and measure responses to electronic communications. For one embodiment as described in detail herein, the platform tracks electronic communications and stores, distributes, and analyzes electronic communications from companies to users, where the users have user accounts (e.g. email addresses, social media accounts, mobile telephone numbers, etc.) that have been identified to receive such communications. Such tracking is helpful for evaluating and managing mass/directed communications for their effectiveness (e.g. through statistics and data providing penetration rates, response rates, read rates, completion rates, and others). Exemplary campaigns include advertising campaigns, which are tracked by interested entities, such as retailers, marketing agencies, polling agencies, and others. Such entities are interested in tracking and analyzing communications and response metrics. One application for an embodiment provides client relationship management (CRM) tools for monitoring and measuring such campaigns. The electronic communications may be emails, text messages, videos, social media messages, etc. An embodiment provides various facilities, data management, response tracking, response analysis, and reports on messaging campaigns (as advertisements) for advertisers, retailers, and the like. Such exemplary features include providing: response recording and retention of telephone messages campaigns (e.g. SMS data and call details that have content tailored to the an advertisement campaign); facilities to monitor and obtain data on campaigns of competitors; analysis tools to examine how campaigns may message different audiences (but from the same site); and facilities to test, monitor, evaluate, and obtain data for messaging campaigns having one or more variations, e.g. different advertisements set for different regions and/or demographics. For an embodiment, messaging campaigns may be deployed and tracked in jurisdictions where users cannot obtain a phone number via traditional service providers (e.g., Twilio, etc.) As noted, the platform provides tracking tools for retailers, marketing agencies, polling agencies and other entities. For the sake of the disclosure, aspects of one platform are described for use by a retailer/advertisers interested in tracking its advertisement campaigns and those of its competitors.

An aspect of an embodiment provides systems and methods of analyzing data and communications for an electronic messaging campaign. Facilities for an embodiment comprise: managing a database containing messaging campaigns and users receiving the communications; creating a set of user accounts for users to be exposed to a first messaging campaign, the user accounts including user details, email accounts and short message service (SMS) numbers (or other equivalent “telephone” numbers that may be associated with an electronic communication device); tracking the email accounts for email messages received relating to the first messaging campaign; analyzing the user accounts of the email accounts against criteria associated with the first messaging campaign; tracking the SMS numbers for SMS messages received relating to the first messaging campaign; and analyzing the user accounts of the SMS messages received against parameters associated with the first messaging campaign. For a first user account of the user accounts: its email account is selected from a reserved set of email accounts from a list of virtual email accounts; its SMS number is selected from a reserved set of SMS numbers from a list of virtual SMS numbers; and its device is a virtual electronic device. Additional aspects of an embodiment enable processing of such elements through instructions on a processor.

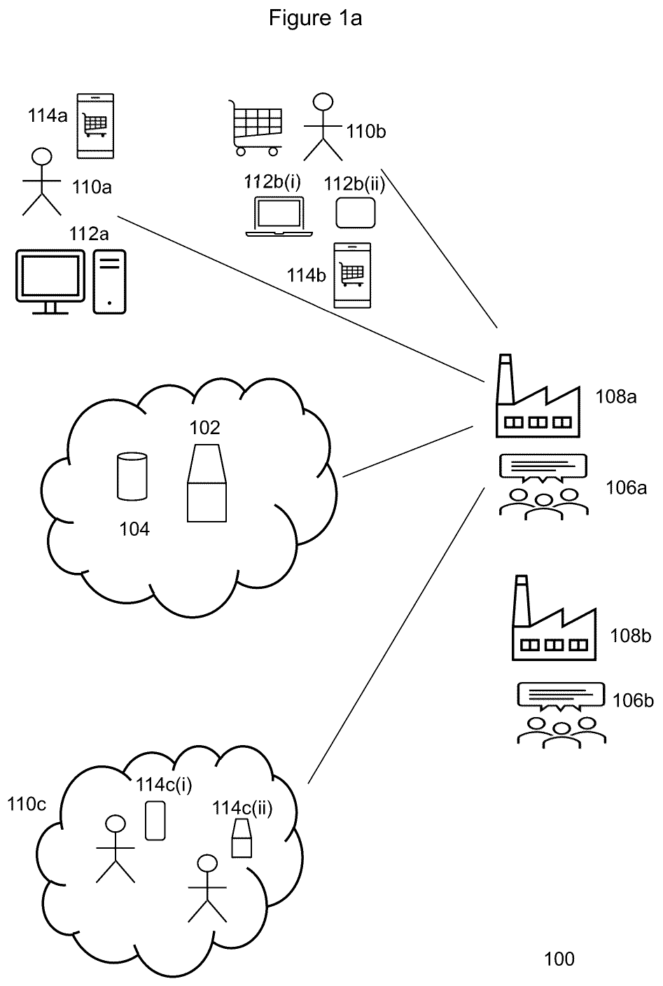

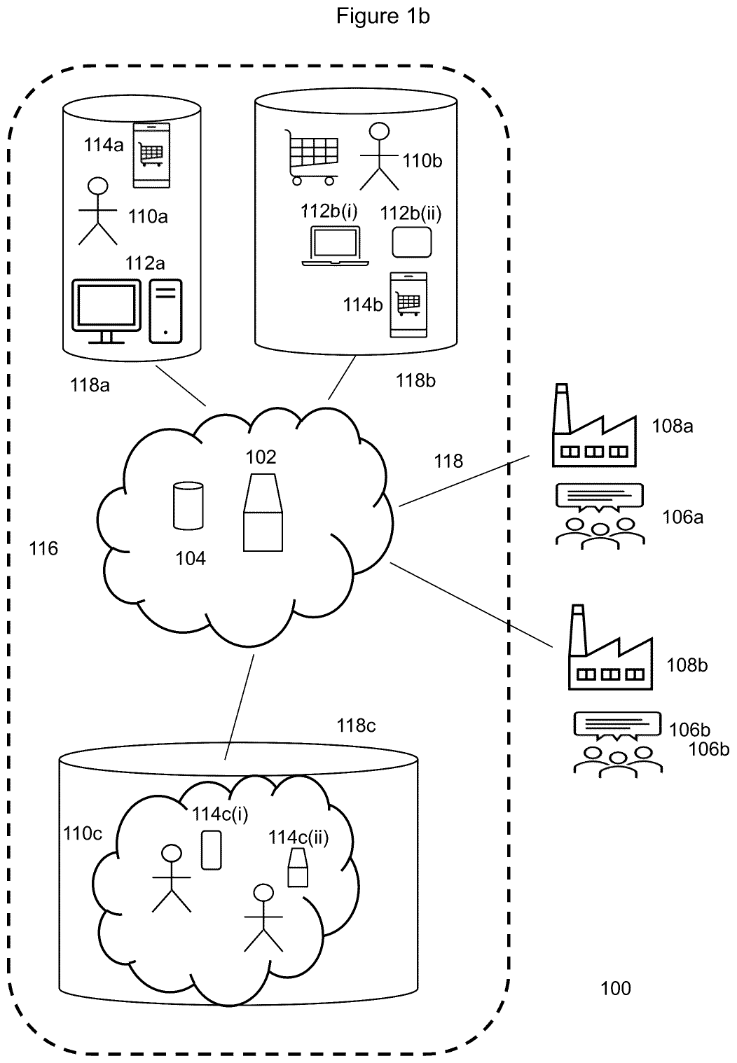

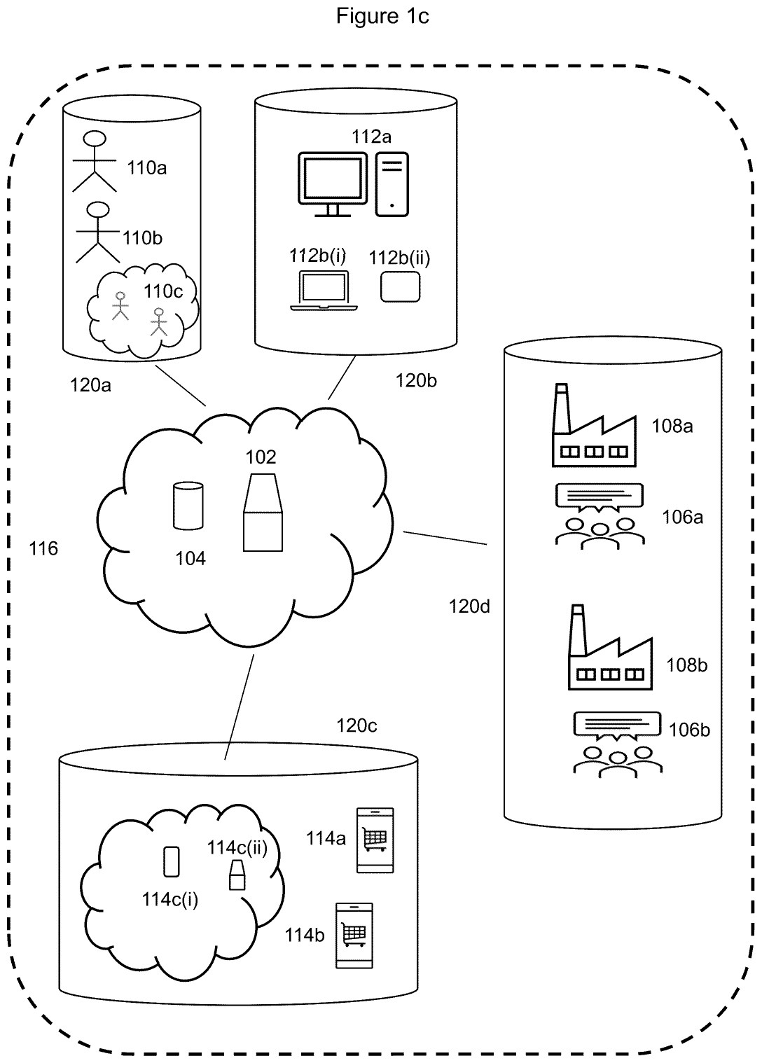

Turning now to FIG. 1a, features of an embodiment are described and shown in environment 100. Therein an instance of an embodiment is shown as messaging tracking platform 102 with related electronic data for a messaging campaign stored in database 104. For the sake of example, a messaging campaign is described herein as an advertising campaign and its various messages would be various email and electronic text messages promoting the advertised item/service. The advertisements are for various retailers. In this example, platform 102 has facilities to send digital message/advertisement campaigns 106 from various advertisers/retailers 108 to users 110 to their electronic computing devices 112 and/or mobile communication devices 114. Mobile devices 114 typically have a mobile number associated with them to receive voice communications, text messages, SMS messages, etc. Throughout this disclosure, it will be appreciated that a reference to an SMS number is not limiting per se to strictly SMS numbers, where other “telephone” /identification numbers may be used in addition to, or instead of, an SMS number used to identify that device 114 (and/or computing devices 112) to a network for other communications. Such other numbers may be PINs, and others. Globally, such contact numbers (SMS, telephone, etc.) for a device, such as device 114 is referred to herein as device contact numbers. Group 110c represents a logical group of users (e.g. a family of users). It will be appreciated that platform 102 may be implemented in tracking messaging campaigns for other companies, service providers, electronic gaming houses, entities, governments, and organizations instead of retailer 108.

Users 110 will have personal information data points based on date of birth, gender, residence, and other related data points. Different levels of specificity may be captured for data point. For example, the user's age may be the user's exact age, the user's age group (e.g., 0-10 years old, 11-20 years old, etc.); and the user's residence may be based on the user's street address, postal code, city, county, province/state, country, etc.).

Users 110 may have various electronic accounts (e.g. email accounts, social media accounts, WhatsApp accounts, Signal accounts, Telegram accounts, etc.) which such users 110 access through their devices 112 through installed communication software, internet browsers, social network interfaces, email communication software etc. installed on devices 112. Computing devices 112 may be typical computers, laptops, tablets, etc. that have communication capabilities with other devices through exemplary data/and or telephone communication networks. When a computing device 112 connects to the internet, its connection point will have an IP address, thereby providing one data point of identification for that device 112.

Mobile communication devices 114 may be typical cell phones, tablets, etc. Typically, a device 114 will need to activate an account with a selected data/mobile communication network managed by a network operator (e.g. Bell Canada, Verizon, etc.) to enable communications by that device 114 to other devices 112, 114 through that network. That device 114 will have a “telephone/mobile” number assigned to it (or assigned its SIM card or e-SIM card) by the network operator. The mobile number is a unique Mobile Station Integrated Services Digital Network (“MSISDN”) number. The MSISDN number has several sequential parts, including an area code, a prefix, and a line number, e.g. (555)-123-1212. It will be seen that accounts associated with actual, unreserved numbers may be associated with physical devices 112/114.

An embodiment may store data relating to users 110 in database 104, which may include data as provided in Table A below:

TABLE A
Exemplary User record

| Field | Value |
|---|---|
| Last Name | Smith |
| First Name | Jim |
| User ID | 0001 |
| Type: | Real / Virtual / randomized |
| Email | jsmith@email.com |
| Mobile | 212-555-1212 |
| Date of Birth | 25 Jan. 1942 |
| Country of residence | Canada |
| City of residence | Toronto |
| Street Address | 123 Main Street |
| Province / State | Ontario |
| Postal / ZIP code | M5H 4E3 |
| Interests | Bowling |
| Advertisement response | Browser / incomplete |
| profile | shopper / shopper / |
| | frequent shopper |

For an embodiment, a user record may be referred to as a “Table Record”.

For an exemplary retailer 108, data relating to the advertiser (here a retailer) and its advertisement campaign(s) may be captured in database 104, including data as provided in Table B below:

TABLE B
Exemplary Advertiser record

| Field | Value |
|---|---|
| Company Name | ABC Inc. |
| Company ID | 0001 |
| Email | jsmith@company.com |
| Address | Toronto, Ontario |
| Industry | Retail |
| Campaign 1: Title | Ad. #1 |
| Campaign 1: Geography | Canada |
| Campaign 1: Outlets | Email, SMS |
| Campaign 1: website | www.ad.com |
| Campaign 1: Data: | Email messages, SMS text |
| | messages, website data, |
| | performance statistics on |
| | each |
| Campaign 1: Restrictions: | Males only |
| Campaign 1: Blacklist items | No females |
| Campaign 1: Whitelist items | Males above 18 years old |
| Campaign 2: Geography | New York State |
| Campaign 2: Outlets | SMS |
| Campaign 2: Data: | SMS messages |
| Campaign 2: Restrictions: | Males only |

For an exemplary retailer 108, data relating to the retailer and its advertisement campaign(s) may be captured in database 104, including data as provided in Table C below:

TABLE C
Exemplary Advertisement record

| Field | Value |
|---|---|
| Company Name | ABC Inc. |
| Company ID | 0001 |
| Email | jsmith@company.com |
| Address | Toronto |
| Industry | Clothing retailer |
| Campaign 1: Title | Ad. #1 |
| Campaign 1: Geography | Canada |
| Campaign 1: Communications | Email, SMS |
| Campaign 1: Tag | Custom tag name / value |
| | used as a tracking tag for |
| | marking campaigns/users |
| | having a common attribute, |
| | (e.g., male, Ontario, etc.) |
| Campaign 1: Type / Lifecycle | Custom type/stage value |
| stage | used as a marker for a |
| | current state of a |
| | compaign/user, (e.g. |
| | Account empty, Account |
| | replenished, etc.) |
| Campaign 1: Journeys | Journey 1 |
| Campaign 1: Data and identifiers | Email 1; SMS 1 |
| Campaign 1: Restrictions | Males only |
| Campaign 1: Blacklist items | No females |
| Campaign 1: Whitelist items | Males above 18 years old |
| Campaign 2: Geography | New York State |
| Campaign 2: Communications | SMS |
| Campaign 2: Journeys | Journey 2 |
| Campaign 2: Data and identifiers | SMS 1 |
| Campaign 2: Restrictions | Males only |

In Table C, the “Tag” field provides a place to store a tracking tag for marking campaigns/users having a common attribute. This permits tracking of multiple different campaigns for a common element. For example, if an advertiser is running two different campaigns for a product (Campaigns 1 and 2), it may be able to identify each Campaign as being part of a collective study by providing a common value in their Tag field. As a further example, if the advertiser is interesting in tracking results relating to males for the Campaigns, the tag fields may be completed with “male”. Platform 102 may then extract relevant Campaigns marked with “male” in their tag fields and compare data and performances.

In Table C, the “Type/Lifecycle” field provides a place to store a marker for a current pre-set state of a user/campaign. This permits analysis of a campaign at specific times/events during its execution. For example, if an advertiser is operating a purchasing platform, the “Type/Lifecycle” field can be populated with values for a particular user's account at a particular time/event, for example when the user's account is empty or has just been replenished. Thereafter, platform 102 may then track how the campaign reacts to such a marker. Following in an “account empty” marker, platform 102 may collect data on how the campaign reacts or does not react to detecting such a status.

For an exemplary campaign, various data and statistics can be collected in monitoring received communications (e.g., email to confirm order, SMS message to cancel order, WhatsApp message to check status, etc.) and launching responding communications (e.g. email and SMS to confirm order details, SMS message to confirm cancellation), which may be captured in database 104 as a log of data as provided in Table D below:

TABLE D
Campaign Communication log

| Field | Value |
|---|---|
| Campaign | Campaign 1 |
| Communication 1 | Email 1 |
| Communication 1 timestamp | Jan. 01, 2023 |
| Communication 1 Event | Place order |
| Communication 1 Type | SMS / Email / voice call / |
| | message app (e.g., |
| | WhatsApp, Signal, |
| | Telegram) |
| Communication 1 Action | Send email confirming order |
| Communication 1 Action | Retain copy of full email |
| Details | |
| Communication 2 | Text 1 |
| Communication 2 timestamp | Jan. 01, 2023 |
| Communication 2 Event | Inquiry |
| Communication 2 Type | SMS / Email / voice call |
| Communication 2 Action | Sent email confirming |
| | cancellation |

For an exemplary campaign, for its various communications (e.g., email, SMS messages) that are generated, received, and provided and other data (images, voice recordings, text) may be captured in database 104 in a series of linked records, where each record is a specific communication. It will be seen that a full communication record for a campaign may comprise a series of linked records. Tables E1 and E2 provide exemplary linked communication records, showing linkages through contents of specific fields (“Preceding communication” and “Following communication/action” fields).

TABLE E1
First Communication record

| Field | Value |
|---|---|
| Communication type | Email |
| Communication identifier | Email 1 |
| Campaign | Campaign 1 |
| Text | Text file 1 |
| Journey | Journey 1 |
| Preceding communication | Email 0 |
| Following communication / | SMS 1 on reply |
| action | |

TABLE E2
Second Communication record

| Field | Value |
|---|---|
| Communication type | SMS |
| Communication identifier | SMS 1 |
| Campaign | Campaign 1 |
| Text | Text file 2 |
| Journey | Journey 1 |
| Preceding communication | Email 1 |
| Following communication / | Email 2 |
| action | |

It will be appreciated that the records provided in the Tables above may be dynamically populated as information is captured by platform 102. As such, some fields may be nil at a given point in time. As well, additional fields and data may be provided in any of the Tables to accommodate data and operational requirements for a given implementation of platform 102.

In an exemplary execution of an advertisement campaign 106, retailer 108 would have profile and contact data for users 110. Campaign 106 may utilize electronic outlets, such as one or more of: email messaging; text messaging; telephone messages; and/or social media posts or blasts, again where specific digital advertisement campaigns are developed for each specific platform and deployed following conventions for each platform. Campaign 106 may also utilize traditional media outlets, such as one or more of: print (e.g., for billboards, newspaper advertisements, magazine advertisements, etc.); radio; and/or television, where specific audio/visual advertisement campaigns are developed and deployed for each outlet.

As an example, advertisement campaign 106a for retailer 108a has profile and contact data for users 110a, 110b, and group of users 110c. Campaign 106a has an email campaign and a text message campaign. Using user profiles and contact data (which may be provided as data as listed for each user per Table A), for the email campaign, one or more email messages are sent to users 110a-c to their respective email accounts; and for text message email campaign, one or more text messages are sent to users 110a-c to their respective mobile numbers. Specific emails/text messages may be tailored for users 110 matching criteria for that campaign (e.g. email message labelled “Type 1” is sent to users 110 that reside in Canada, but email message labelled “Type 2” is sent to users 110 that reside in the United States). Emails are sent through typical email transmission channels to email accounts for users 110. Text messages are sent through typical text message telephone channels to devices assigned to mobile numbers of users 110. Once such email and text messages are sent, platform 102 has facilities and processes to monitor and analyze aspects of the campaigns (as will be described in more detail below).

Now, referring to FIG. 1b, further details of an embodiment's facilities are described that facilitate monitoring and analyzing aspects of such campaigns. Therein, platform 102 effectively creates a virtual set of users 110a-c, each individually associated with computing devices 112a-b, and mobile devices 114a-c, as shown, all which may be logically considered to be located within virtual network 116. Each virtual user 110 will have a data set 118 associated with it (providing, for example, exemplary data per Table A). Data sets 118 may be created, stored, and updated in database 104. Advertisers 108 communicate with platform 102 via communication links 118.

Now, referring to FIG. 1c, data in database 104, relating to users 110, computing devices 112, mobile devices 114 and advertisers 108 is graphically shown in logical data groups 120, e.g. table 120a providing a list of users 110a-c; table 120b providing a list of computing devices 112a-b; table 120c providing a list of mobile devices 114a-c; and table 120d providing a list of advertisers 108, advertising campaigns 106, related communications, related communication paths, reply actions and other actions. Such tables 120 may be dynamically created from database 104 through specific database queries. Data in tables 120 facilitate deploying components of an advertisement campaign 106. Data for selected tables are described in more detail below.

For email and text message communications, platform 102 mimics and replaces direct communications between advertiser 108a to devices 112 by intercepting/rerouting such communications as communications between platform 102 and advertiser 108 through communication links 118. In this embodiment, a mixture of “real” users/agents (with physical devices 112) and virtual users/agents (with virtual accounts and devices) are provided. The virtual users/agents/accounts may be provided through third party providers, such as Twilio.

An embodiment deploys a mix of real and virtual account, providing a flexible mix and control over demographics a target audience for a campaign under test by an embodiment. For example, where some jurisdictions may have limited facilities to deploy virtual users (e.g., limited or restricted access to Twilio accounts), platform 102 may utilize its virtual accounts to monitor a campaign's effectiveness. Virtual accounts also provide flexibilities in establishing multiple variations on user/agent profiles that can be tested (e.g. a set of virtual users having specifically designed demographics and age ranges).

As well, the use of virtual agents assists in conducting “know your client” (KYC) tests for accounts, as virtual accounts will typically fail KYC typical tests (e.g. uploading a copy of the user's passport to test whether the campaign is adhering to relevant regulatory requirements. For example, for certain gambling/gaming websites, the users must reside in a specific jurisdiction and be of a minimum age. Different virtual accounts can be established that are either adhering to or not adhering to such requirements. Platform 102 facilitates testing a campaign's compliance to such regulations by assessing how the campaign interacts with such different virtual accounts. For example, platform 102 may assess whether the campaign properly or improperly provides responses to users that are permitted or are not permitted to access the campaign (e.g. per territorial and/or age restrictions established for the campaign due to regulations).

Devices 112 and 114 may have local client software, e.g. an “app”, installed thereon (not shown). Such clients are typically an application program interface (API) that communicate with platform 102.

As platform 102 may be accessed by vendors and representatives of the retailer, different access portals and related graphical user interfaces (GUIs) are provided for retailers 108, depending on whether they are operated by a vendor or by a representative of the retailer.

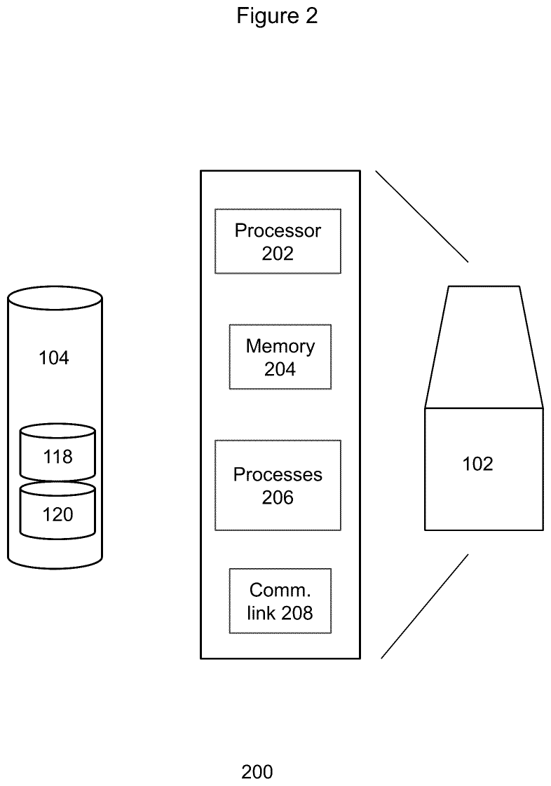

FIG. 2 shows components of platform 102, which may be implemented as server having commercially-available processor(s) with related components. The server may be implemented as one or more server(s) or other computationally-capable computing device(s). Platform 102 may be accessed directly at its terminal or remotely through a remote device 112. Platform 102 has processor(s) 202, memory 204, access to database 104, and communication link module 208.

For platform 102, one or more processes 206 provide instructions to processor 202 to execute commands and data transactions implementing features of an embodiment performed by platform 102. One or more functions of platform 102 may be distributed among several devices. It will be appreciated that devices 112 and 114 may have similar corresponding components and structures to comparable components shown for platform 102. Database 104 stores vendors' records accessed by platform 102 and may be contained within system 106 or may be accessed remotely. Database 104 stores records and data relating to campaign, including digital files for the campaign, records relating to electronic distributions of the campaign and contact information, and statistics and analysis of the campaign. For database 104, a data record may be referred to as a record, data record, event, document, advertisement, item, search result, data element, etc. Other processes that provide operational and/or functional features for an embodiment may be provided through remote facilities (e.g. external, web-based processes providing external access to one or more facilities of an embodiment).

A campaign is a set of messages, advertisements, and actions that are generated and sent to a set of users. A campaign has access to the users' contact information (e.g. email addresses and phone numbers), which are typically provided via accounts associated with the campaign (e.g. through a set of retailer's access accounts established by the users). As a campaign is initiated and progresses, as users provide certain actions/responses/non-actions at various time through the campaign, the campaign would then send responses/actions to the user (e.g. various emails or text messages or actions initiated at a relevant website). The progression is a script of messages/actions for the campaign is typically preset. Platform 102 has facilities to store the related scripts and execute the related actions.

Now, further details are provided on exemplary processes 206 for an exemplary embodiment where platform 102 manages an exemplary advertisement campaign. For a digital advertisement campaign, an embodiment provides facilities to create and use a set of telephone numbers and/or email accounts that are populated into contact responses for the campaign, thereby providing a tracking mechanism (i.e. via the email address and the telephone number) to track responses for the campaign.

First, platform management process 206a is provided which implements overall management and coordination of campaigns for retailer 108. Users for retailer 108 may access platform 102 and conduct various administrative functions relating to an advertisement 106 (e.g. creating a new campaign and its parameters, creating user profiles for new targets for the campaign, managing current campaigns and users, etc. These functions include (but are not limited to): accessing database 104; accepting data; processing data for storage into database 104; accepting external data, requests, and commands from retailers 108 (FIG. 1) and other sources; creating and generating database queries and extracting results to database 104; initiating data analysis reports; updating and generating reports; updating and generating advertisements; integrating data and related commands among processes, and data; and implementing other processes for an embodiment.

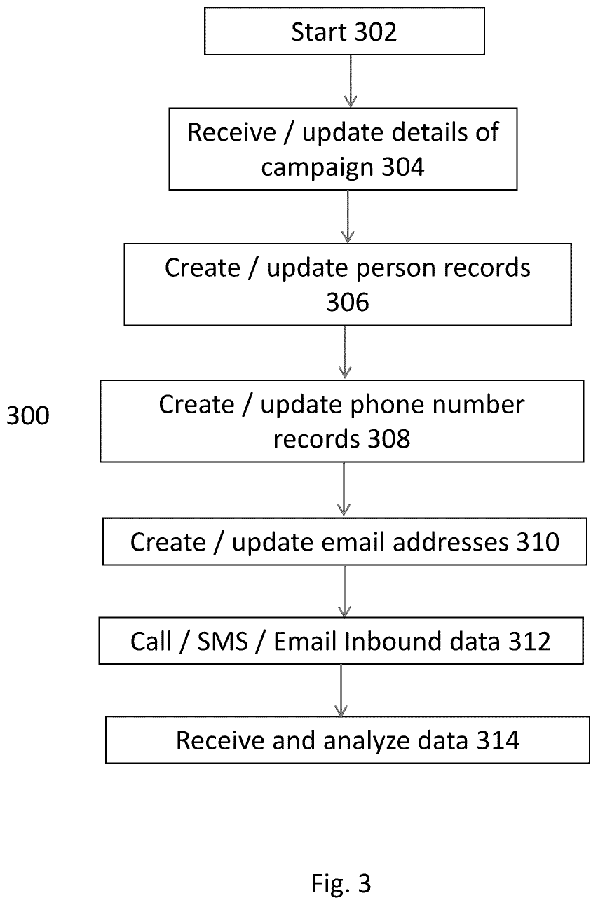

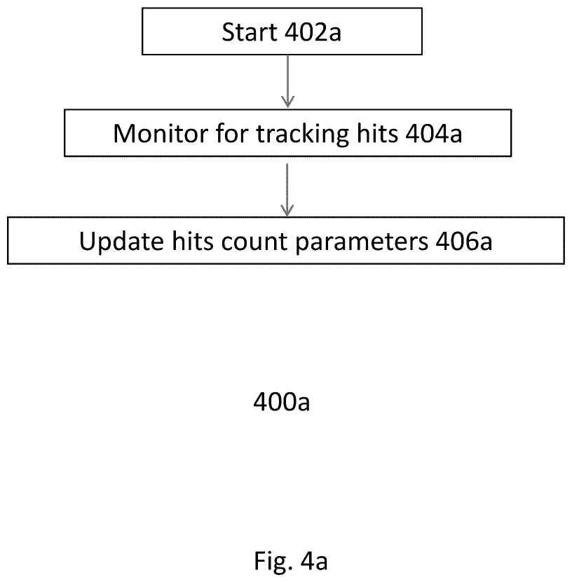

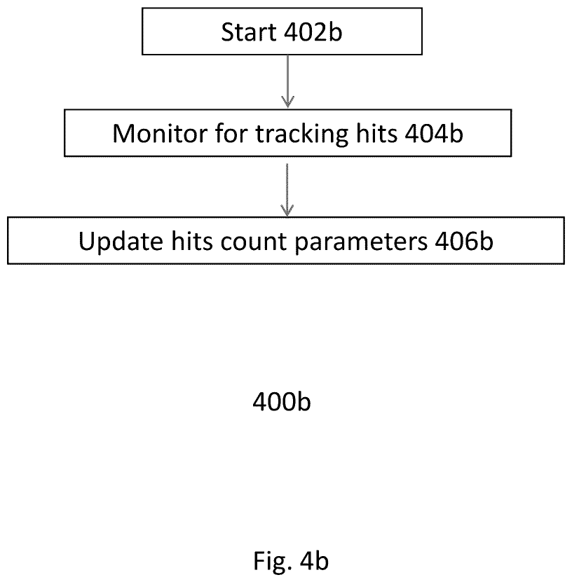

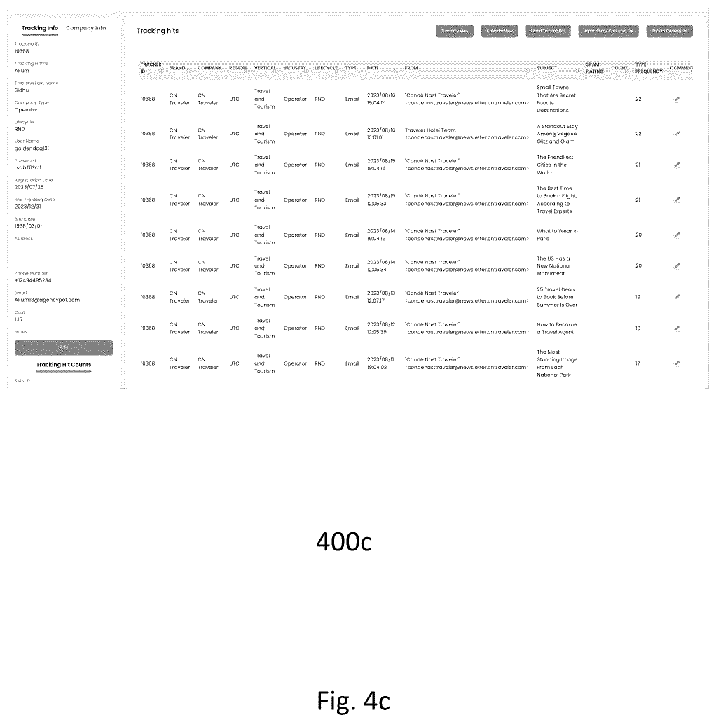

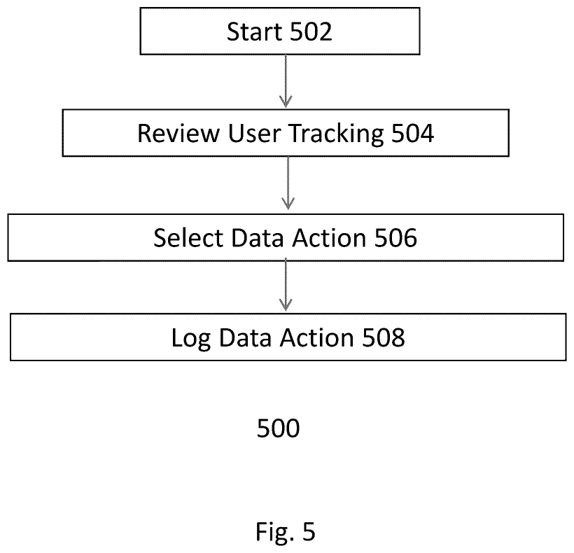

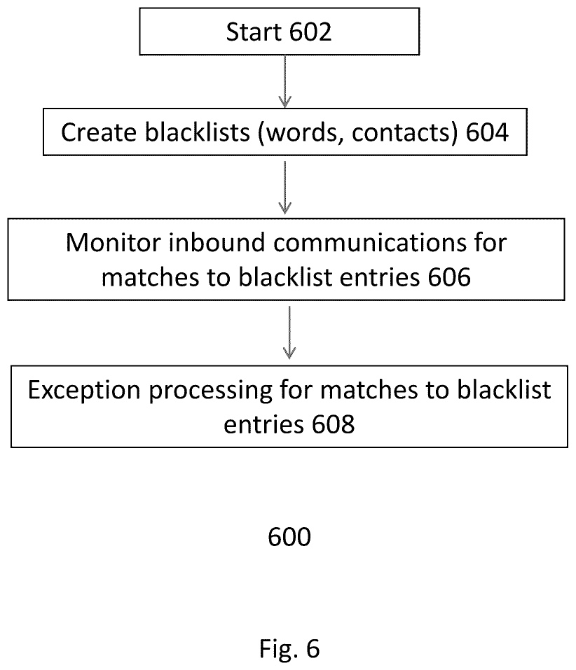

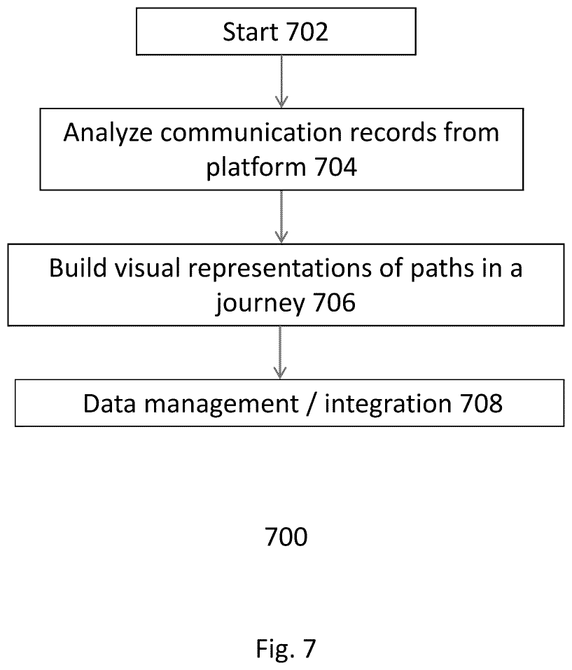

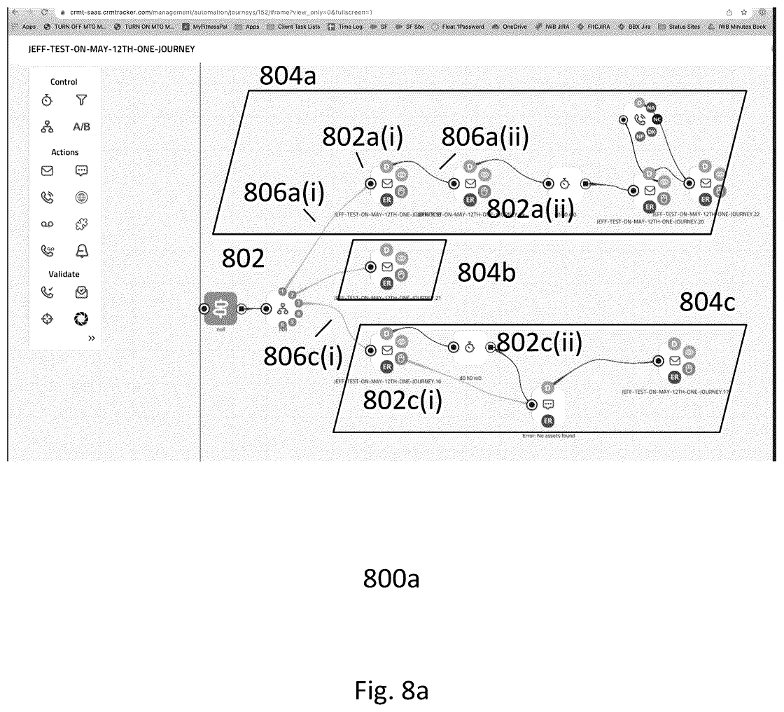

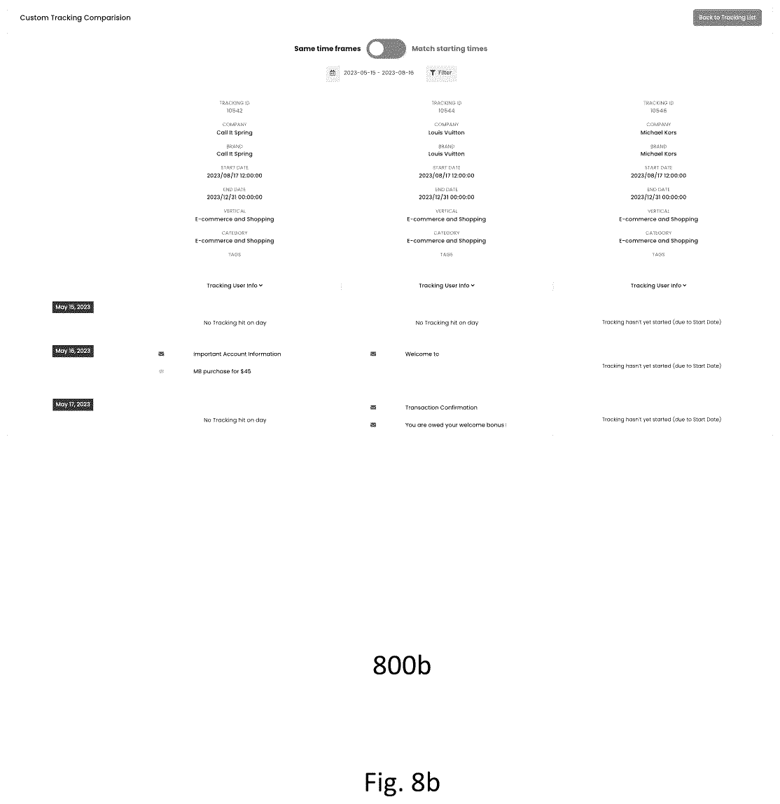

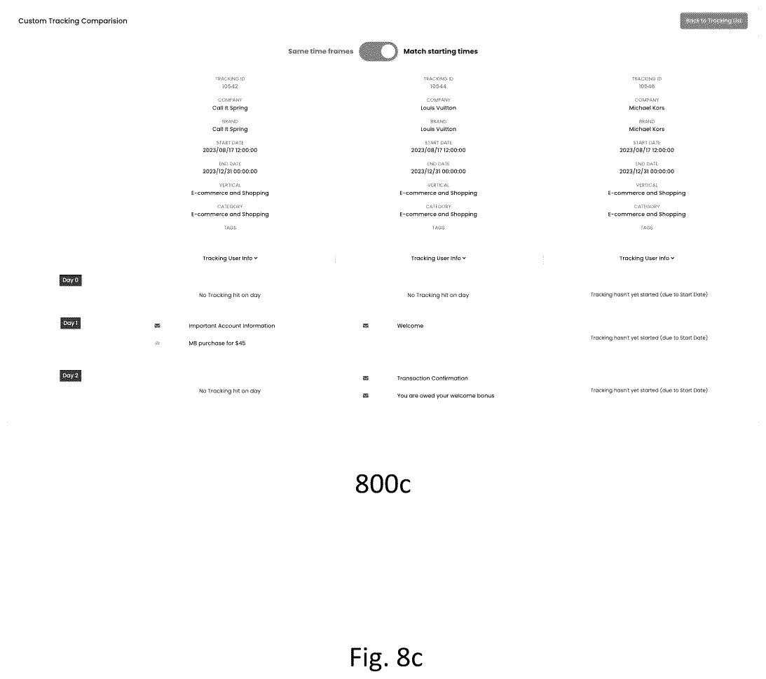

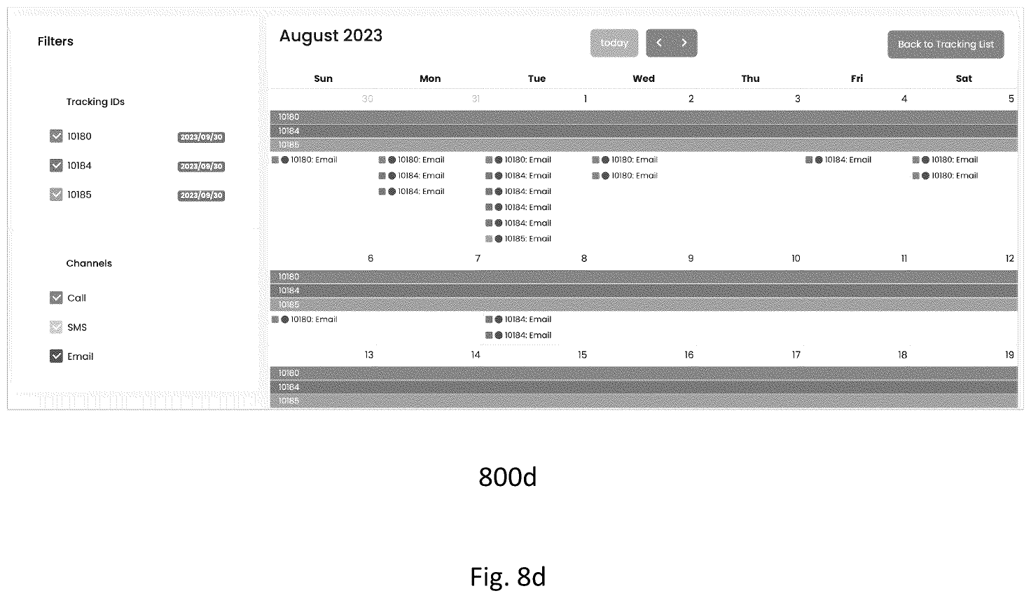

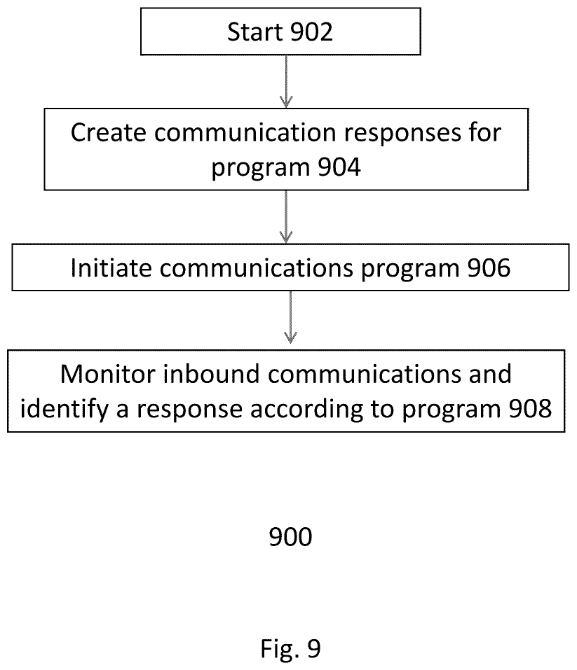

For an embodiment, process 206a comprises several sub-processes implementing functions described above, including: administrative processing sub-process 206b (see FIG. 3); email campaign tracking sub-process 206c (see FIG. 4a); SMS campaign tracking sub-process 206d (see FIG. 4b); response data analysis sub-process 206e (see FIG. 5); exceptions processing sub-process 206f (see FIG. 6); communication program mapping sub-process 206g (see FIGS. 7 and 8); communication response mapping sub-process 206h (see FIG. 9); and contacts process 206i. Each process may be executed in a separate processing thread, allowing concurrent/simultaneous operation of two or more processes as the underlying computational facilities in platform 102 permit.

Further details of algorithms of selected sub-process are now provided.

Referring to FIG. 3, algorithm 300 illustrates a general set of processes/actions executed collectively by platform management sub-process 206b in processing orders at platform 102 as conducted by a user for retailer 108 (e.g., an advertising program manager). Start process 302 is the initiation of sub-process 206b, which may include procedures to instantiate variables, set parameters, set communication links, and configure other ancillary items. From start 302, once its initiations are completed, algorithm 300 moves to process 304, which allows the user to update/change details, data, and parameters for an existing campaign or to create a new campaign and enter data relating to its details. Exemplary data is shown in Table B above.

Once the details of a campaign are updated/created, algorithm 300 moves to

processes 306, 308, and 310, which allows the user to create personal records for “targets” of the campaign. Exemplary data is shown in Table A above. The embodiment permits the user to edit an existing record for a “person” or to create a new (virtual) person. An embodiment utilizes data tokens representing accounts and email addresses to enable system 102 to access third party APIs that manage the virtual email accounts bypassing the typical requirement to provide a user name and password to the API. Other parameters for the person may be set by the user (again, per fields in Table A). For telephone numbers, an embodiment initiates an external API call to a third-party telephone number registry. The registry returns a set of numbers following the requested parameters (e.g. phone numbers for a specific country or region). For email accounts, an embodiment initiates an external API call to a third-party email account registry. Again, the registry returns a set of email accounts. For example, for email accounts, a user may select to generate email accounts from a list of available domains (which have been pre-provided to platform 102). An API request is provided to create an alias under existing accounts to generate the email accounts. Then platform 102 receives the email user's related token. For one implementation, email accounts and telephone numbers may be externally obtained and reserved from providers and then “hard-coded” for access into database 104 for use by platform 102. In other implementation, email accounts and telephone numbers may be dynamically obtained.

As noted earlier, such email users may be associated with real email addresses and telephone numbers attributed to physical devices 112/114. As such, such email users are envisioned to be real persons that can interact with devices 112/114. As such, an embodiment has additional flexibilities and capabilities for actions/reactions provided by such users to events in a campaign being evaluated. For example, to evaluate certain order processing features of a campaign, a real user may implement and fully execute an online purchase relating to the campaign (e.g., by manually entering an order from the campaign's online order facilities and properly completing all order information and payment requirements) through her device 112, while another real user may start, but not fully complete or abandon a separate order through his device 114. The campaign is expected to then process both orders and provide appropriate responses and reports to the users and its system. Platform 102 would then track the campaign's expected and actual responses to both orders, including messages sent and timing of such messages. For incomplete and complete orders, platform 102 will track response messages and their timing for each scenario, which may highlight gaps or deficiencies in the campaign for both successful and abandoned orders. Also, a real user may provide a real-time, context-dependent response to an action/state of an order (e.g. change an order, change a quantity for an order, etc.), which is not preprogrammed by platform 102. As such, a real user can provide intelligent actions/reactions to messages received. Once the real user provides his response, platform 102 will provide a response per the campaign's script, to which the relevant data on responses and actions will be tracked by platform 102 for the campaign.

Next, at processes 312, inbound data processes are established for SMS and email accounts. An embodiment uses CRON processes to implement scheduled, timed operations. For an embodiment, described CRON processes are executed at fairly short intervals, e.g., every 5 minutes. One set of CRON processes make initial authentication API calls to each email account/telephone number provider once per phone number.

In process 312, for each telephone number provider, it sends a request to each provider (e.g. a request to its API) to get a list of calls from its logs (recall that each number has a unique ID) that are new since the last request. If a new call has been sent to a telephone number not recognized by platform 102 (i.e. the number is not in database 104), process 312 sends another request to that provider to get further details about the call or SMS and then creates a new record in database 104.

For each email account, it sends a request to each email account provider (e.g., a request to its API) to get a list of emails from its logs that are new since the last request. If a new email has been sent to an address for an account not recognized by platform 102 (i.e. it is not in database 104), process 312 sends another request to that provider to get further details about the account and then creates a new record in database 104, where the record may include contents of the email (e.g. HTML). The email is then marked as “read” in database 104. The email may then be analyzed for performance/boundary issues. For example, one analytical tool is a spam content analysis. Several spam review tools are provided by third parties, such as SpamAssassin. Process 312 may forward a copy of the email to such service(s) and then send a request to the service to provide its analysis (e.g. its spam score), which is then stored in database 104 against the email.

With email accounts and telephone numbers established, process 314 provides a set of performance, testing, and analytic tools that can individually or collectively be initiated. Exemplary processes 314 are noted below, each provided with a different letter suffix to distinguish them from each other (e.g. 314a, 314b, etc.), such processes 314 may correspond to various processes 206 where noted.

Retailer analysis process 314a provides investigative tools to review and determine if a change has been implemented on a target entity's website. Process 314a initiates a CRON process that accesses and analyzes a target website to see if new data has been posted related to that website. Any change may reflect new information about the company associated with the website and the company's developments, products, and brands. If new data is detected, a call is made to get retrieve more details. As well, process 314a receives details on performance statistics for the website (e.g. visitors, views, rankings, etc.) for websites, companies, and brands. Web traffic hits are recorded into database 104. Performance analytics capture and index public data from various external website pages to obtain metrics and comparatives.

Randomized user process 314b provides facilities for platform 102 to create and monitor a random user for use as a specific user to be tracked in platform 102. Process 314b makes an API call to a third-party randomizer (e.g. to randomuser.me) with details for the random user. Once the randomizer creates the related random user details, platform 102 receives an API request with the name and address. This data is stored s details on database 102 (e.g. see Table A).

Private website process 314c provides facilities for platform 102 to create and monitor activities for private websites, (e.g. an “app” store that is accessed thought a password). Once a user having a tracking record in platform 102 accesses the private website (with the user's credentials), process 314c, then through an app on the user's device obtains the user's credentials for the user's tracking record and process 314c connects to database 104. Process 314c validates the user and if validated, process 314c can review and update log data for the user (e.g. date/time of last email/call logged, tracking hits, etc.). In this context, validation means verifying the user's name/password for correctness, and once validated, the user's account is logged into platform 102 and thereafter data from the user's device can be uploaded to platform 102.

Analysis process 314d provides facilities for platform 102 to analyze operational and performance data and make suggestions for next actions. For example, as platform 102 has collected data on the campaign and how the campaign did, or did not, impact the advertiser's web traffic, process 314d can analyse that data and make predictions and suggestions for next actions. For example, if the data indicates that action “×” was conducted by a user, which appears to impart an increase in web traffic, then platform 102 can identify this impact and make suggestions to the advertiser which would predictively, mimic/enhance/repeat the actions for additional users or to the same user. Process 314d reviews data about emails, SMSs, frequencies, journals, etc. against data for other others in the industry and other industry practices, third party analytics, e.g. DataBricks, may be used. Optimizations may be identified and reports (e.g. optimal timing for sending emails, specifics on offers in the email, etc.). As well, comparative analyses are provided (e.g. comparing results of two different campaigns).

Journey process 314e provides facilities for platform 102 to record, track, and visually show a series of communication progressions in a campaign, where such progressions are referred to as “journeys”. Tables E1 and E2 described above show exemplary data of communications that can be stored, linked, extracted, and analyzed for a particular campaign by platform 102.

For example, in one journey, an email is sent from the advertiser to a user. There are expected actions/non-actions after sending the email (e.g. the user would reply to the advertiser, would not reply, would block, etc.). For each action/non-action from the initial email, a set of secondary actions are set for each item. Process 314e records all communications, and extracts time and relevant data and produces provides specific analytic results.

TABLE F
Journey Record

| Field | Value |
|---|---|
| Journey Name | Journey 1 |
| Parent Journey | Journey 1 |
| Campaign | Campaign 1 |
| Text | Text file 1 |
| Preceding action | Start |
| Action 1: Proceeding action | SMS 1 on reply |
| Action 2: Proceeding action | Delay |

Data export process 314f provides facilities for platform 102 to export and share data. Process 314f permits a user to expressly export data in database 104 (to which the user has privileges) to other users and third parties.

Contacts process 314g provides facilities for platform 102 to extract, import, and communicate with various contacts.

Now, referring to FIGS. 4a, 4b, and 4c, algorithms 400a and 400b illustrates a general set of processes/actions executed collectively by email and text sub-process 206c and 206d in tracking emails and calls monitored by at platform 102 in response to campaign 106, expanding on features described in FIG. 3. For each algorithm 400a and 400b, from its start 402, once its initiations are completed, its moves to process 404, where tracking for email/SMS “hits” are monitored. Next, at process 406, such hits are recorded for analysis. While not shown, it will be appreciated that other reconciliations/actions/notifications may be provided in algorithm 400. In FIG. 4c, GUI screen 400c shows an exemplary snapshot of data (“hits”) relating to emails processed and analyzed in algorithms 400a and 400b.

Referring to FIG. 5, algorithm 500 illustrate general sets of processes/actions executed by sub-process 206e in processing and reviewing user data commands, expanding on features described in FIG. 3. Sub-process 206e has start process 502, then process 504, a user is provided various options and commands to review and analyse data. Then at process 506 the related data action is initiated. At process 508 the related data action is logged. It will be appreciated that that logging may be initiated at other instances within algorithm 500.

Referring to FIG. 6, algorithm 600 illustrate general sets of processes/actions executed by sub-process 206f in processing and establishing parameters for an advertisement campaign, expanding on features described in FIG. 3. Sub-process 206f has start process 602, then process 604, a user is provided various options and commands to set blacklists and whitelists for a campaign. Then at process 606, monitors for the campaign are initiated and data recorded. Then at process 608, exceptions are tracked and reported.

Referring to FIG. 7, FIGS. 8a, 8b, and 8c, and Tables C, D, E1, and E2, algorithm 700 illustrates general sets of processes/actions executed by sub-process 206g in extracting communication records and building a visual representation of connected communications in paths as a campaign's journey map (FIG. 800). Sub-process 206g has start process 702, then process 704, communication records (e.g., data represented from Tables C, D, E1, and E2) are analyzed to identify communication paths and timings between communications sent/received. The analysis may include tracking/identifying various timing and action/reaction relationships between actions in a campaign (e.g. after an order inquiry message is sent by a user to platform 102, the response sent or the response action initiated by platform 102 is noted, including the response type (e.g. email sent, SMS sent, order cancelled) and the time for initiating such action. Thereafter a further response from the user can then be tracked and analyzed. In process 706, the connections and data are visually mapped in a graphical representation (FIG. 8) showing the connecting communications. With a campaign's various communications sent and received tracked and recorded, an embodiment can then analyze the related data and generate graphical views of communication progressions created during the campaign that an administrator for the campaign can review. As part of the analysis, latency information may be calculated. Latency generally refers to time between receiving an action (e.g. timestamp of receipt of a user's email cancelling an order) and execution a reaction (e.g. timestamp of sending a response to the user's email and the type of response, e.g. either an email or a SMS message). The type of response action (e.g. email or SMS) and any subsequent responses/actions by the user can identify the effectiveness of the particular action. For example, it the resulting data may show that user actions are more responsive to SMS messages (which may be sent more quickly than an email response. Assigned costs for a response may also be tracked by an embodiment, such as costs to send an email message and costs to send an SMS message. It will be appreciated that actual IT costs incurred by the advertiser to send one email to one user may be less than the cost to send a comparable SMS message. For campaign's full rollout to a large set of users, these costs may become notable. In process 708, data management processes are implemented, which may include exporting data to external CRM system, analyzing the data to create/identify additional messaging campaigns, and others.

Graphical views of exemplary communication progressions for a campaign are shown in FIGS. 8a-8d. FIG. 8a shows graphical layout 800a of communications in a campaign (oldest from left to right) of communication elements 802 (for example, emails, SMS messages), that have a series of expected return data (shown as icons on the right side), which are linked via links 806 to other sequential communication elements 802. A set for related communication elements are grouped together in paths 804. For an embodiment, these connected elements are referred to as communication “journeys”. Each journey visually shows how a campaign's actions are received by a user and how a user's actions are received by the campaign.

FIG. 8b shows table layout 800b of communications in a campaign shown by columns of messages oldest from the top with responses added to each column by date. Adjacent columns show different types of messages sent to users on the same originating date (as a starting point). Each column shows a progression of actions/reactions for its communication sent on the originating date. As such, results of a particular communication action in one column can be compared to results of other communications tracked in other columns.

FIG. 8c shows table layout 800c of communications in a campaign shown by columns of messages oldest from the top with responses added to each column by date. Adjacent columns show different types of messages sent to users that were originated on different dates as a starting point, but normalized to show each starting date from a relative starting date (e.g. Day 0). Again, each column shows a progression of actions/reactions for its particular communication sent on the originating date that can be compared.

FIG. 8c shows table layout 800c of communications in a campaign shown by columns of messages oldest from the top with responses added to each column by date. Adjacent columns show different types of messages sent to users that were originated on different dates as a starting point, but normalized to show each starting date from a relative starting date (e.g. Day 0). Again, each column shows a progression of actions/reactions for its particular communication sent on the originating date that can be compared.

FIG. 8d shows calendar table layout 800d of communications in a campaign shown as entries in dates of a month's calendar.

Referring to FIG. 9, algorithm 900 illustrates general sets of processes/actions executed by sub-process 206h in processing and executing response actions for an advertisement campaign. The response actions can be to send reply messages in the same format (e.g. via email) and/or through a different channel (e.g. SMS messages, PIN messages, Apple imessages, WhatsApp messages, Telegram messages, or other electronic communication formats that may be received by the device). This provides multiple and different actions and responses to received communications. Various responses/actions can be set in a campaign to be sent in response to receipt of a message that matches a particular criteria. For example, if the user sends a “cancel order” message, either as an email or as activating a “cancel order” button on related website, this pre-set criteria triggers a campaign to send a confirmation message to the user. Notably, generally, an SMS response message to a received email provides a faster response mechanism than providing an email response, as some users generally react to SMS messages more readily than email reply messages. Sub-process 206h has start process 902, then process 904, for a campaign, a set of responses for a program are established and provided to platform 102. Then at process 906, the campaign is initiated, and actions and responses tracked. During execution at process 908, as inbound communications are received, and predefined response actions are initiated. It will be seen that this process provides very quick response times for new messages. As well, as noted above, costs for different responses for different campaigns may also be tracked by an embodiment, such as costs to send an email message and costs to send an SMS message, which can be another factor in tracking and evaluating responses and campaigns. The “tags” and “lifecycle” values (Table C) can also be used to further extract specific data points for one or more campaigns for their collective analysis.

As noted earlier, contact data is stored in platform 102 (as per process 314g). Per process 206i, such contact data is managed, where process 206i provides bulk extraction of contact information from platform 102 and bulk transplanting of contact information into platform 102 through database 104

It will also be appreciated that alternatives implementations of any process or algorithm described herein may be provided implementing loops and actions in different orders and arrangements (e.g. in parallel with other processes), while still implementing actions and features as described.

The above embodiment describes a retailer-centric implementation. It will be appreciated that other embodiments may provide industry-centric or regulatory-centric platforms, with suitable modifications made to the data, the data fields, the trigger conditions, the GUIs, etc. An exemplary regulatory platform is for the gambling industry, where a regulator may establish multiple accounts on various gambling sites (i.e., the “retailers”) and monitor how such gambling sites interact with their users. For example, there may be geographic and age boundaries that need to be respected for advertisers. As such, data from Tables A, B, and C and for a regulator may be adjusted accordingly. As such, an embodiment provides through platform 102, facilities for retailers to monitor their advertising campaigns and to test their competitors' campaigns and for regulator to monitor activities of their regulated entities.

It will be appreciated that various tasks, commands, and processes provided by an embodiment may be managed exclusively by either retailer 108, process 206, and/or platform 102 or through allocating specific tasks among the entities, with appropriate messaging and signalling being provided. For example, an embodiment may implement a logical allocation of such tasks between retailer 108 and process 206a, depending on various factors, such as location of relevant data, communications needed between the devices, relative processing capacities of the devices, and others. For one implementation, retailer 108 provides processes to receive and analyze data generated and sent on device 112 and requests relevant metadata from obtained from platform 102.

The various features described above may be implemented in, and fully automated by processes executed by general-purpose electronic devices, including but not limited to data center servers, PCs, tablets, laptops, and mobile phones. The processes may be stored in any type or types of computer storage device or memory. It should be understood that the various processes, actions, and steps may alternatively be implemented in-whole or in-part within specially designed hardware.

It will be appreciated that all processes, algorithms, devices, modules, servers, databases, database querying systems, and elements described herein for embodiments and related processes, actions, steps or functions may be implemented using known programming techniques, languages, scripts (such as Common Gateway Interface scripts), and algorithms, such as PHP, Java, C++, Python, SQL, and others. Such processes may be executed in whole or in part on one or more of platform 102 and/or retailers 108. Apps on retailers 108 may provide selected GUI, input/output, data processing, and data collection features and interfaces described herein to platform 102. Although the processes, services and modules described herein are implemented in software operating on an electronic device having the display, it will be appreciated that some or all functions of these processes may be provided in a separate device(s) or server(s) that communicate with the electronic device. The titles of processes and platforms are provided as a convenience to provide labels and assign functions to certain processes. It is not required that a process perform only its functions as described above. As such, specific functionalities for each application or process may be moved between processes or separated into different processes. Processes may be contained within other processes. Different signaling techniques may be used to communicate information between applications using known programming techniques. Known data storage, access and update algorithms allow data to be shared between applications. It will further be appreciated that other applications and systems on devices and servers may be executing concurrently with other processes. Known mathematical algorithms, such as order processing algorithms, database update algorithms, and others, may be implemented using programming techniques known in the art. As such, any of modules (or parts thereof) may be structured to operate in as a “background” application on devices and servers, respectively, using programming techniques known in the art.

It will be appreciated that the embodiments relating to clients, servers, services, state machines and systems may be implemented in a combination of electronic hardware, firmware, and software. The firmware and software may be implemented as a series of processes, applications and/or modules that provide the functionalities described herein. The algorithms and processes described herein may be executed in different order(s). Interrupt routines may be used. Data may be stored in volatile and non-volatile devices described herein and may be updated by the hardware, firmware and/or software.

As used herein, the wording “and/or” is intended to represent an inclusive-or. That is, “X and/or Y” is intended to mean X or Y or both.

In this disclosure, where a threshold or measured value is provided as an approximate value (for example, when the threshold is qualified with the word “about”), a range of values will be understood to be valid for that value. For example, for a threshold stated as an approximate value, a range of about 25% larger and 25% smaller than the stated value may be used. Thresholds, values, measurements, and dimensions of features are illustrative of embodiments and are not limiting unless noted. Further, as an example, a “sufficient” match with a given threshold may be a value that is within the provided threshold, having regard to the approximate value applicable to the threshold and the understood range of values (over and under) that may be applied for that threshold.

Although this disclosure has been described in terms of certain embodiments and applications, other embodiments and applications that are apparent to those of ordinary skill in the art, including embodiments which do not provide all of the features and advantages set forth herein, are also within the scope of this disclosure. Accordingly, the scope of the present disclosure is intended to be defined only by reference to the following claims.

1. A communications system for analyzing electronic messaging campaign relating to an online ordering platform, the system utilizing accounts associated with actual users and accounts associated with virtual users to track received electronic responses resulting from the electronic messaging campaign, the system comprising:
a processor executing instructions that:
manage a database containing the messaging campaign and users receiving electronic messages in the campaign;
the processor further executing instructions that:
manage user accounts in the database relating to the users to be exposed to a first messaging campaign of the messaging campaign, the user accounts of the messaging campaign user details, email accounts, and device contact numbers;
the processor further executing instructions that for the first messaging campaign
track the email accounts for email messages received relating to the first messaging campaign;
analyze the user accounts of the email accounts against restriction criteria associated with the first messaging campaign;
upon determining that one user account contravenes the restriction criteria, providing a message to one user that the restriction criteria are contravened for the order:
track the device contact numbers for messages received relating to the first messaging campaign; and
analyze the user accounts of the messages received against parameters associated with the first messaging campaign;
the processor further executing instructions that
identify a response electronic message to be sent to a target user account when a message received from the user account matches a criteria;
send the response message to the target user account;
the processor further executing instructions that
receive a communication sent from a first user account of the user accounts to the system;
identify a response to the communication;
send the response to the first user account; and
track the communication and response in the database,
wherein for the first user account
its email account is selected from a reserved set of email accounts from a list of virtual email accounts;
its device contact number is selected from a reserved set of numbers from a list of virtual device contact numbers; and
its device is a virtual electronic devices:
wherein for a second user account of the user accounts
its email account is associated with an actual user;
its device contact number is a SMS number associated with the actual user; and
its device is a physical device;
and
wherein for the online ordering platform
the status of the online order is an incomplete order: and
the second message is an order status inquiry.

2. (canceled)

3. (canceled)

4. The communications analysis system as claimed in claim 1, wherein:
the communication is an email message; and
the response is an SMS message.

5. The communications analysis system as claimed in claim 1, wherein:
after the actual user sends the communication to cancel an order in the platform to the system, the system tracks events around the communication and the order.

6. The communications analysis system as claimed in claim 1, wherein:
before the communication is sent the first user account, privileges of the first user account are compared against restrictions for the first messaging campaign.

7. The communications analysis system as claimed in claim 1, wherein:
communications between the first user account and the system are tracked and analyzed and a graphical representation of the communications is generated.

8. The communications analysis system as claimed in claim 1, wherein the processor further executes instructions that:
associate the user accounts with a second messaging campaign;
track the email accounts for email messages received relating to the second messaging campaign;
analyze the users accounts of the email accounts against parameters associated with the second messaging campaign;
track the SMS numbers for SMS messages received relating to the second messaging campaign;
analyze the user accounts of the SMS messages received against parameters associated with the second messaging campaign; and
generate data relating to performance criteria for the first and second messaging campaigns.

9. The communications analysis system as claimed in claim 8, wherein the data relates to response times for the first and second messaging campaigns.

10. The communications analysis system as claimed in claim 9, wherein the data further relates to cost parameters for the first and second messaging campaigns.

11. The communications analysis system as claimed in claim 1, wherein the processor further executes instructions that:
track and measure a latency between receipt of the message and sending of the response message.

12. The communications analysis system as claimed in claim 11, wherein the processor further executes instructions that:
for the second messaging campaign, identify a second response electronic message to be sent to the user account when the message is received from the user account matching the criteria;
send the second response message to the user account; and
track and measure a latency between receipt of the message and sending of the second response message.

13. The communications analysis system as claimed in claim 8, wherein the processor further executes instructions that:
create a graphical user interface (GUI) showing a connection of messages between the user account and the system with their timing aspects and types of communication.

14. The communications analysis system as claimed in claim 8, wherein the processor further executes instructions that:
upon determining that one account of the user accounts does not meet the criteria of the first messaging campaign, send a message to that one account notifying of the unmet criteria.

15. The communications analysis system as claimed in claim 14, wherein the unmet criteria relates to either a location of the user account or an age of the user holding the user account.

16. A method for a customizing electronic messages for an electronic messaging campaign associated with an online ordering platform that track received electronic responses resulting from the electronic messaging campaign and utilize accounts associated with actual users and accounts associated with virtual users, comprising executing instructions on a processor that manage a database containing the messaging campaign and users receiving the communications;
manage user accounts in the database relating to the users to be exposed to a first messaging campaign of the messaging campaign, the user accounts of the messaging campaign user details, email accounts and device contact numbers;
track the email accounts for email messages received relating to the first messaging campaign;
analyze the user accounts of the email accounts against restriction criteria associated with the first messaging campaign;
upon determining that one user account contravenes the restriction criteria, providing a message to one user that the restriction criteria are contravened for the order;
track the device contact numbers for messages received relating to the first messaging campaign;
analyze the user accounts of the messages received against parameters associated with the first messaging campaign;
receive a communication sent from a first user account of the user accounts to the system;
identify a response to the communication;
send the response to the first user account;
track the communication and response in the database;
associate the user accounts with a second messaging campaign;
track the email accounts for email messages received relating to the second messaging campaign;
analyze the users accounts of the email accounts against parameters associated with the second messaging campaign;
track the SMS numbers for SMS messages received relating to the second messaging campaign;
analyze the user accounts of the SMS messages received against parameters associated with the second messaging campaign; and
generate data relating to performance criteria for the first and second messaging campaigns,
wherein for a first user account of the user accounts
its email account is selected from a reserved set of email accounts from a list of virtual email accounts;
its device contact number is selected from a reserved set of device contact numbers from a list of virtual device contact numbers; and
its device is a virtual electronic device;
and
wherein for the online ordering platform
the status of the online order is an incomplete order and
the second message is an order status inquiry

17. (canceled)

18. (cancelled)

19. The method for analyzing electronic messaging campaigns as claimed in claim 16, wherein the data relates to response times for the first and second messaging campaigns.

20. The method for analyzing electronic messaging campaigns as claimed in claim 19, wherein the data further relates to cost parameters for the first and second messaging campaigns.

21. A communications analysis system for analyzing an electronic messaging campaign relating to an online ordering platform to analyze restriction criteria to the platform and to promote completion of incomplete orders, the system reacting to received electronic responses resulting from electronic messages sent relating to the electronic messaging campaign utilizing accounts associated with actual users and accounts associated with virtual users, the system comprising:
a processor executing instructions that manage
a database containing the first and second messages for the messaging campaign and users associated with the messaging campaign;
user accounts in the database relating to the users to be exposed to the first message; and
user details, email accounts, and device contact numbers of the user accounts;
the processor further executing instructions that track
email accounts for email messages responding to the first message; and
device contact numbers for user accounts of such responding email messages;
the processor further executing instructions that
analyze user accounts of the email accounts against restriction criteria associated with the first message;
analyze the user accounts against parameters associated with the first message; and
upon determining that one user account contravenes the restriction criteria, provide a message to one user that the restriction criteria are contravened for the order;
the processor further executing instructions that analyze a status of an order in the online ordering platform associated with one of the user accounts and contents of such responding email messages to identify a second message as an SMS message as a followup for the first message to be sent to the user account associated with the order;
upon determining that the status of the order is incomplete identify a second message as an SMS message as a followup for the first message to be sent to the user account associated with the order, the second message providing an inquiry statement on the order:
send the second message to the user account associated with the order;
track the first and second messages in the database;
track the SMS numbers for SMS messages received relating to the second message;
analyze the user accounts of the SMS messages received against parameters associated with the second message; and
generate data relating to performance criteria for the first and second messaging campaigns,
wherein for a first user account of the user accounts, its
email account is selected from a reserved set of email accounts from a list of virtual email accounts;
device contact number is selected from a reserved set of numbers from a list of virtual device contact numbers; and
device is a virtual electronic device,
wherein for a second user account of the user accounts, its
email account is associated with an actual user,
device contact number is a SMS number associated with the actual user; and
device is a physical device.
